(19) United States
(12) Patent Application Publication
(10) Pub. No.: US 2004/0248073 A1
(43) Pub. Date: Dec. 9, 2004

(54) Paper card with video

(76) Inventors: Ronda Lyn Pinkerman, Oberlin, KS (US); Jeremy Pinkerman, Oberlin, KS (US)

Correspondence Address: GATEWAY, INC., ATTN: SCOTT CHARLES RICHARDSON, 610 GATEWAY DRIVE, MAIL DROP Y-04, N. SIOUX CITY, SD, 57049, US

(21) Appl. No.: 10/851,372

(22) Filed: May 21, 2004

Related U.S. Application Data
(60) Provisional application No. 60/472,216, filed on May 21, 2003.

(51) Int. Cl. G09B 5/00

(52) U.S. Cl. 434/308; 345/204

(57) ABSTRACT

A video card capable of emulating a greeting card provides a visual and audible message. The card has a central folding portion, a first inner planar surface, a second inner planar surface, a planar display attached to one of the planar surfaces. A control circuit includes a processor, memory, and an audio transducer coupled to the display. The processor provides a bidirectional programming interface to provide interactive programming of the messages. One or more programming parameters are presented on the planar display. Input associated with the programming parameters is received from an input device such as a touch screen associated with the display. The planar display is a thin film display such as an Organic Light Emitting Diode (OLED) thin film display.

### CROSS REFERENCE TO RELATED APPLICATIONS

The present invention is related to, and claims priority from U.S. Provisional Application Ser. No. 60/472,216 filed May 21, 2003, the contents of which are incorporated herein by reference.

### BACKGROUND OF THE INVENTION

1. Field of the Invention

The present invention relates to video presentation using thin displays, and more specifically to programming and presenting video and video/audio using a thin display in a paper media style format such as greeting card format or the like.

2. Brief Description of the Related Art

As technology advances, improvements in size, speed, and capabilities of modem processors, displays, and audio circuits, have made seemingly mundane objects such as greeting cards, a ripe area for automation. Using a greeting card style object to present video and/or audio information has become possible with these advances. Such advances include advances in the area of input technology such as touch screen technology, display technology such as thin display technology made using Organic Light Emitting Diode (OLED) technology, and the like. Also processor miniaturization has made it possible to insert a computer capable of providing near full scale computing capabilities within the form factor dictated by the medium format, e.g. the greeting card format, or the like.

Many systems are available which have added capabilities to conventional greeting cards. One message card which makes use of many technologies is described in U.S. Pat. No. 5,652,606 issued on Jul. 29, 1997 to Sasaki, et al (hereinafter “Sasaki”). The message card of Sasaki, for example, uses a flexible substrate to display visual images and play audio messages. One drawback to Sasaki, is the lack of a programming interface. Sasaki does describe that writing terminals are provided but fails to disclose acceptable ways to program the card either internally or externally.

Therefore, it would be appreciated in the art for a video paper card, capable of being programmed through, for example, an interface. Such an interface would simplify the programming and reprogramming of the card.

### SUMMARY OF THE INVENTION

Accordingly, a device such as a video paper card with an interactive programming interface is provided for simplifying card programming for the display of visual images, video, audio, a combination of video and audio, or the like. An exemplary device is capable of emulating a medium, such as a greeting card, a newspaper, magazine or the like and is capable of providing a visual message and/or an audible message. The device has a central folding portion as would a greeting card, newspaper, magazine or the like, a first inner planar surface extending in a first direction from the central folding portion, a second inner planar surface extending in a second direction opposite the first direction from the central folding portion, the first and second inner surfaces facing one another when the device is folded in a closed configuration. A planar display is preferably attached to at least one of the inner planar surfaces and a control circuit coupled to the planar display is provided to control operation of the device. The control circuit preferably includes a processor, a memory, and an audio transducer such as a speaker or piezoelectric transducer or the like, for generating audio signals associated with the audio message. The processor may further provide a bi-directional programming interface including a wireless interface, so as to provide interactive programming of the visual and the audible message. Accordingly, one or more programming parameters, e.g. visual message contents, or audible message selections or the like, may be presented on the planar display. The exemplary device may further include an input device, and the processor may preferably receive input associated with the programming parameters displayed or otherwise presented on the planar display from the input device. It will be appreciated that the input device can include a touch screen associated with the planar display, or the like. The planar display preferably includes a thin film display such as an Organic Light Emitting Diode (OLED), or the like.

In accordance with other exemplary embodiments, a device such as a video paper card is capable of providing a visual message and/or an audible message. The device has a central folding portion, a first inner planar surface extending in a first direction from the central folding portion, a second inner planar surface extending in a second direction opposite the first direction from the central folding portion. The first and second inner surfaces face one another when the device is folded in a closed configuration. The device further includes a planar display attached to at least one of the inner planar surfaces, and an activation device such as a switch or other sensor. A control circuit is preferably coupled to the planar display and the activation device and further includes a processor, memory, and an audio transducer such as a speaker, piezoelectric transducer, or the like. A bi-directional programming interface including a wireless interface may be provided so as to provide interactive programming of the visual and the audible message. The processor preferably presents the visual and the audible message when a signal from the activation device, such as a switch closure or opening indication is received. It will be appreciated that the planar display is preferably a thin film display such as an Organic Light Emitting Diode (OLED) thin film display, or the like.

In accordance with still another exemplary embodiment, a card such as a video paper card, is capable of providing a visual message and/or an audible message. The card includes a planar surface and a planar display attached to the planar surface. A control circuit coupled to the planar display preferably includes a processor, a bi-directional programming interface including a wireless interface, a memory and an audio transducer such as a speaker, piezoelectric transducer, or the like. The processor provides the bi-directional programming interface so as to provide interactive programming of the messages over the programming interface. The processor may connect with an external programming device over the bi-directional programming interface and may transfer programming parameters to the external device over the bi-directional programming interface. Input may be received from the external programming device associated with the programming parameters. It will be appreciated that the planar display is preferably a thin film display such as an Organic Light Emitting Diode (OLED) thin film display, or the like.

In accordance with one exemplary embodiment, the present invention uses a card stock-like piece of material with a thin flexible display, such as an OLED display to present video information. Audio information may also be provided using a speaker, audio transducer or the like. Unlike conventional video paper devices, the present invention does not use separate devices to present the video and/or audio information, and provides an interactive programming interface to simplify programming of the card contents.

In accordance with some exemplary embodiments, a thin film display is provided with an associated memory chip and related circuitry, along with a capacitance activated area such as a touch screen area either in a text area or an image area on the display or on the card to “activate” certain areas in order to display video and/or play back audio information.

In accordance with still other exemplary embodiments, an appearance similar to a conventional greeting card is provided. In such embodiments the sender of the card programs a message using the programming interface. Programming the card or device may be accomplished by linking to the interactive programming interface of the device through a wired or a wireless circuit, device, or means using a computer or other device. The card may further be programmed using the interactive programming interface to program the sender's message without the use of separate devices.

Such embodiments may be use to enhance greeting cards, newspapers, magazines, books, general media, and the like. Thus the present invention provides a means to heighten the impact of communications for individuals with or without access to computer resources.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a diagram illustrating a video paper card in accordance with various exemplary embodiments;

FIG. 2 is a diagram illustrating a video paper card connected to a computer in accordance with various exemplary embodiments; and

FIG. 3 is a block diagram illustrating components of an exemplary video paper card in accordance with various exemplary embodiments.

### DETAILED DESCRIPTION OF THE INVENTION

Accordingly, the present invention in accordance with various exemplary embodiments, is directed to a device such as a video paper card for emulating a medium such as a greeting card or the like.

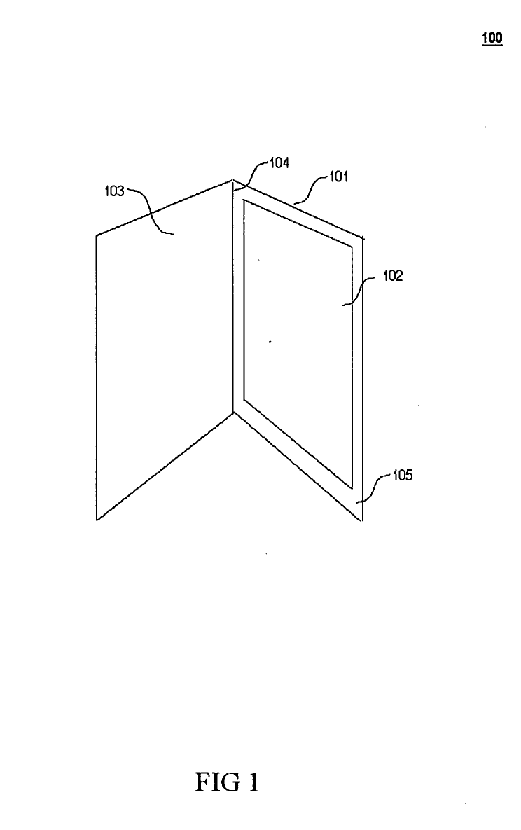

With reference to FIG. 1, exemplary scenario 100 includes device 101 having an inner surface 103, a central fold 104, another inner surface 105, and planar display 102. It will be appreciated that with the exception of planar display 102, device 101 may be made from paper, such as greeting card stock or the like, provided sufficient rigidity and resiliency is present to mechanically support planar display 102, either through glue attachment, insertion into folds or slots in the stock, or the like as would be appreciated by one of ordinary skill.

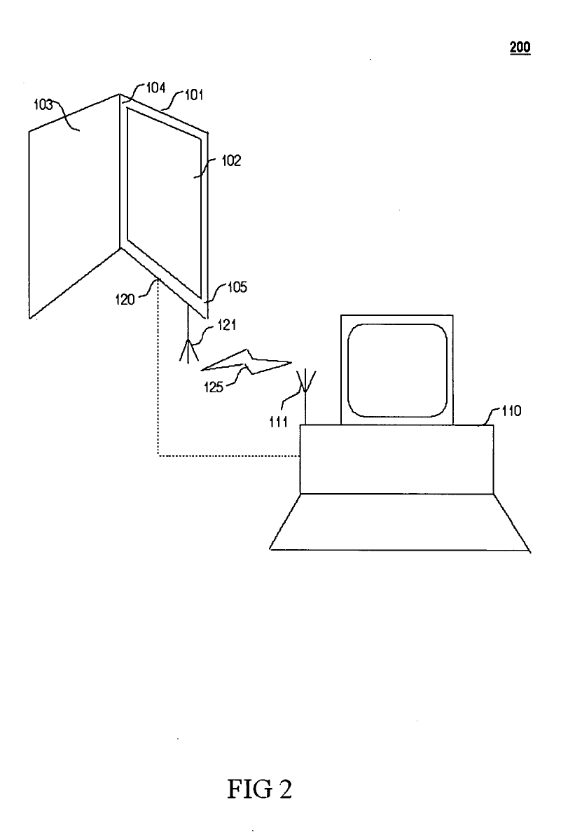

FIG. 2 further illustrates device 101, in exemplary scenario 200, where programming using an external computer 110 is illustrated. It will be appreciated that, using a programming interface to be described in greater detail hereinafter, messages, both audible and visual, may be programmed into device 101 over either a wired connection 120, or a wireless connection 125 provided by antenna 121 on device 101 and antenna 111 provided on external computer 110. It will be appreciated that external computer 110 may be a conventional Personal Computer (PC) type computer, a PDA, a laptop computer, or the like provided that wired connection 120 and/or wireless connection 125 are supported. It will further be appreciated that wired connection 120 may be a parallel or serial connection such a Universal Serial Bus (USB) type connection or another type of data connection or serial data connection as would be known to those of ordinary skill in the art. Wireless connection 125 is preferably a connection established using one of several types of wireless protocols such as 802.11(b), Bluetooth, or the like, although other protocols may also be used. Wireless connection 125 may also include an infrared connection or the like.

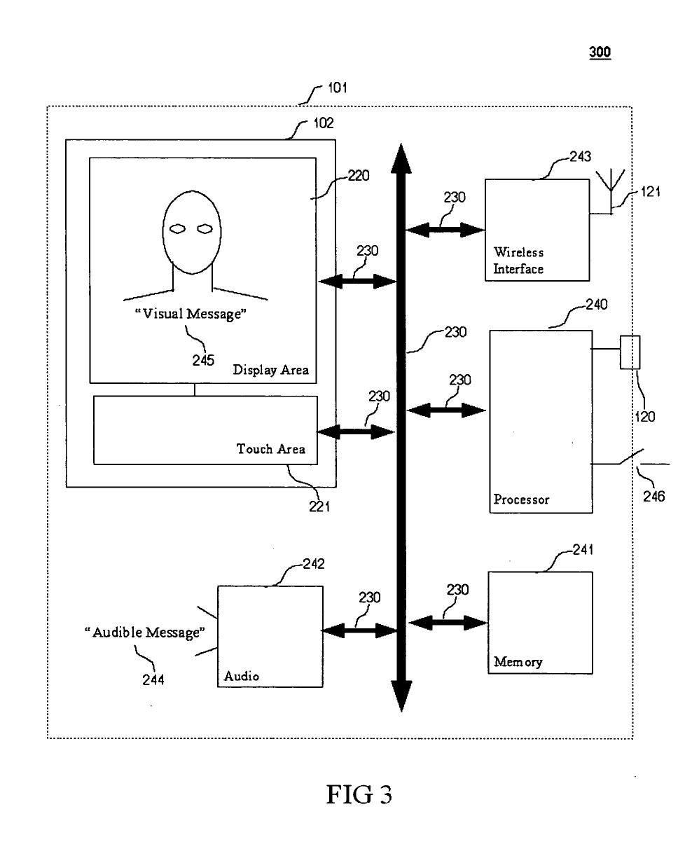

To better appreciate the capabilities of an exemplary card in accordance with the invention, FIG. 3 shows exemplary scenario 300 where device 101 is illustrated in greater detail. It should first be noted that device 101 may include processor 240, with memory 241. Processor 240 may be a small form factor processor as would be known to one of ordinary skill in the art, and, along with other components of device 101 may be mounted on a thin flexible circuit “board” and/or may be integrated into the flexible material used for display 102. Components may further be connected using bus 203 which can be a simple data bus having data lines for communicating between components.

Device 101 further includes audio circuit 242 including a speaker, piezoelectric transducer or the like (not shown) capable of generating audio message 244 which may be a greeting, message, or the like, and can be generated from pre-recorded audio segments, can be constructed from text, or can be recorded from an optional microphone (not shown) which microphone may also be present in external computer 110. In any case, data associated with audio message 244, once programmed, may be stored for example, in memory 241. Visual message 245 may be displayed in display area 220 of display 102 and, like the audio, may consist of a pre-recorded image or video segment stored and retrieved from memory 241 or may be recorded from a camera, such as a digital camera or the like coupled directly over wired connection 120 or wireless connection 125. A camera may also be connected to external computer 110. It will be appreciated by one of ordinary skill that according to various video formats, video message 245 and audio message 244 may be played together as part of a combined multimedia format or may be separately played and synchronized in a manner known to those of ordinary skill.

Processor 240 may further provide a bi-directional programming interface where various pre-recorded messages, or message entry boxes may be presented on either display area 220 of display 102 or on a display associated with external computer 110. The programming interface may be loaded from memory 241 over an external connection 120 or may be loaded from wireless connection 125 provided from wireless interface 243 over antenna 121. In either case, information associated with the programmable parameters can be transferred external computer 110 or to display area 220 to be displayed. Input may be received such as text or selections from radio buttons or the like to program audible message 244 and visual message 245 either from a keyboard associated with external computer 110 if programming is being conducted over wired connection 120 or wireless connection 125 or from input area 221 such as a touch screen area which may be separate from display area 220 or may be integrated with display area 220 such that it overlays certain soft buttons or the like which may be displayed underneath. It will be appreciated that if pre-recorded messages are being presented in display area 220, input area 221 may be superimposed on various selection areas so a user can select what message to be displayed visually or presented audibly, and thus program device 101. Once programmed, activation through switch 246 or the like will result in the message or messages, being presented to, for example, a recipient.

It is believed that the method of the present invention and many of its attendant advantages will be understood by the forgoing description. It is also believed that it will be apparent that various changes may be made in the form, construction and arrangement of the processes and steps associated therewith without departing from the scope and spirit of the invention or without sacrificing all of its material advantages. The form herein before described being merely an explanatory embodiment thereof. It is the intention of the following claims to encompass and include such changes.

What is claimed is:

1. A device capable of emulating a medium, the device capable of providing one or more of a visual message and an audible message, the device comprising:
a central folding portion;
a first inner planar surface extending in a first direction from the central folding portion;
a second inner planar surface extending in a second direction opposite the first direction from the central folding portion, the first and second inner surfaces facing one another when the device is folded in a closed configuration;
a planar display attached to at least one of the first inner planar surface or the second inner planar surface; and
a control circuit coupled to the planar display, the control circuit comprising:
a processor;
a memory coupled to the processor; and
an audio transducer coupled to the processor, the processor configured to:
provide a bidirectional programming interface so as to provide interactive programming of the visual and the audible message.

2. The device according to claim 1, wherein the processor, in providing a bidirectional programming interface is further configured to:
present one or more programming parameters on the planar display.

3. The device according to claim 2, further comprising an input device, and wherein the processor, in providing a bidirectional programming interface is further configured to:
receive input from the input device associated with the one or more programming parameters on the planar display.

4. The device according to claim 1, wherein the input device includes a touch screen associated with the planar display.

5. The device according to claim 1, wherein the planar display is a thin film display.

6. The device according to claim 1, wherein the planar display is a Organic Light Emitting Diode (OLED) thin film display.

7. The device according to claim 1, wherein the medium includes one or more of: a greeting card, a newspaper, and a magazine.

8. The device according to claim 1, wherein the bi-directional programming interface includes a wireless interface.

9. A device capable of providing one or more of a visual message and an audible message, the device comprising:
a central folding portion;
a first inner planar surface extending in a first direction from the central folding portion;
a second inner planar surface extending in a second direction opposite the first direction from the central folding portion, the first and second inner surfaces facing one another when the device is folded in a closed configuration;
a planar display attached to at least one of the first inner planar surface or the second inner planar surface;
an activation device; and
a control circuit coupled to the planar display and the activation device, the control circuit comprising:
a processor;
a memory coupled to the processor; and
an audio transducer coupled to the processor, the processor capable of providing a bi-directional programming interface so as to provide interactive programming of the visual and the audible message, the processor configured to:
present the visual and the audible message when a signal from the activation device is received.

10. The device according to claim 9, wherein the planar display is a thin film display.

11. The device according to claim 9, wherein the planar display is a Organic Light Emitting Diode (OLED) thin film display.

12. The device according to claim 9, wherein the medium includes one or more of: a greeting card, a newspaper, and a magazine.

13. A card capable of providing one or more of a visual message and an audible message, the device comprising:
a planar surface;
a planar display attached to the planar surface; and
a control circuit coupled to the planar display, the control circuit comprising:
a processor;
a bi-directional programming interface coupled to the processor;
a memory coupled to the interface and the processor; and
an audio transducer coupled to the processor, the processor configured to:
provide interactive programming of the visual and the audible message over the bi-directional programming interface.

14. The card according to claim 13, wherein the processor, in providing the interactive programming is further configured to:
connect with an external programming device over the bi-directional programming interface; and
transfer one or more programming parameters to the external device over the bi-directional programming interface.

15. The card according to claim 14, wherein the bi-directional programming interface includes a wireless interface.

16. The card according to claim 14, wherein the processor, in providing the interactive programming is further configured to:
receive input from the external programming device associated with the one or more programming parameters on the planar display.

17. The card according to claim 16, wherein the bi-directional programming interface includes a wireless interface.

18. The card according to claim 13, wherein the planar display is a thin film display.

19. The card according to claim 13, wherein the planar display is a Organic Light Emitting Diode (OLED) thin film display.

20. The card according to claim 13, wherein the bi-directional programming interface includes a wireless interface.
